(19) United States
(12) Patent Application Publication
(10) Pub. No.: US 2026/0346220 A1
(43) Pub. Date: Nov. 5, 2026

(54) COUPLING ELEMENT FOR AN EXTRUDER

(71) Applicant: Flender GmbH, Bocholt (DE)

(72) Inventors: Dirk Steggemann, Bocholt (DE); Niklas Sondermann, Bocholt (DE)

(73) Assignee: Flender GmbH, Bocholt (DE)

(21) Appl. No.: 19/486,775

(22) PCT Filed: May 21, 2024
(86) PCT No.: PCT/EP2024/063944

§ 371 Date: Nov. 21, 2025

(30) Foreign Application Priority Data
May 24, 2023 (EP) 23175037.3

(51) Int. Cl. B01F 35/31; B01F 27/07; B01F 27/1143; B01F 27/213; B01F 27/42; B29B 7/48; F16D 1/10; F16D 9/08

(52) U.S. Cl. CPC B01F 35/31; B01F 27/071; B01F 27/1143; B01F 27/213; B01F 27/42; B29B 7/488; F16D 9/08; B01F 2215/0427; F16D 1/101; F16D 2001/103

(57) ABSTRACT

A coupling element for connecting an extruder screw to a drive unit of a twin screw extruder includes two receiving bushes connected to each other in a connecting region. A first one of two receiving bushes is designed to receive a shaft end of the drive unit and a second one of the two receiving bushes is designed to receive the extruder screw. The connecting region includes a reduced breaking moment in an event of a torsional load relative to an adjacent structural region of the two receiving bushes. The connecting region includes via the bores or the weld seam a reduced breaking moment in an event of a torsional load relative to an adjacent structural region of the two receiving bushes.

### DESCRIPTION

The invention relates to a coupling element for connecting one extruder screw each to a drive unit of a twin screw extruder, comprising two receiving bushes, which are connected to each other in a connecting region, wherein the first receiving bush is provided for receiving a shaft end of the drive unit and the second receiving bush for receiving one of the extruder screws.

Extruder systems are used for mixing, conveying and compacting various materials. The materials are usually heated in the process. This process is realized via one or two rotating extruder screws arranged parallel to each other. Consequently, a distinction is made between single screw extruders and twin screw extruders. In the case of twin screw extruders, the principle of power splitting is used in the transmission and the generated motor torque is divided between two output shafts. Ideally, the output torques of both shafts are identical. The output shafts of the transmission then drive the two extruder screws. There are extruder systems with unidirectionally rotating screws and with counter-rotating screws. In addition, the rotation angles of the two screws are usually synchronized with each other.

Malfunctions in the standard operation, caused for example by impurities or other inhomogeneities in the starting material or cooled material residues from a previous extrusion process, may result in an uneven load distribution of the torque to the output shafts. The system or process necessitates the extruder screws being at a defined axial distance from each other, which limits the outer diameter of the transmission output shafts. The torque density in said parts is accordingly high even at rated load. If load peaks are added due to previously mentioned effects, the overload of individual components may result. There is therefore a constant need to protect the components of an extruder system from overload during standard operation.

EP 2939943 A1 discloses an electronic control system for protecting a system against overload. The torque is measured at the transmission output shafts. If a torque limit value, a gradient limit value of the torque or an impermissibly high vibration is detected, a switchable coupling between the motor and the transmission opens and the rotational speed of the motor is reduced via a frequency converter. EP 3 378 624 A1 describes a safety coupling which has two coupling halves, between which shearing pins are arranged. In the event of an overload, the shearing pins form a predetermined breaking point, shear off and thereby interrupt the transmitted torque. The shearing pins can be replaced and the safety coupling is operational again. However, the safety coupling requires a certain radial installation space, which is not generally provided, especially in the case of twin screw extruders, due to the defined axial distance from each other. WO 2010/109486 A1 describes a connecting adapter for connecting a drive shaft to an extruder shaft, wherein the adapter has a weakened region in order to shear off when a predetermined torque is reached. The safety coupling described in DE 20 2019 106 047 U1 should also be mentioned.

It is the object of the invention to disclose measures with which a coupling element for a twin screw extruder can be provided taking the limited axial distance into account.

The object is achieved by means of a coupling element having the features of claim 1. Preferred refinements are specified in the dependent claims and in the description below and may in each case individually or in combination represent an aspect of the invention. If a feature is presented in combination with another feature, this serves only for simplified illustration of the invention and is in no way intended to mean that this feature cannot also be a development of the invention without the other feature.

One embodiment relates to a coupling element for connecting one extruder screw each to a drive unit of a twin screw extruder, comprising two receiving bushes, which are connected to each other in a connecting region, wherein the first receiving bush is provided for receiving a shaft end of the drive unit and the second receiving bush for receiving one of the extruder screws. The connecting region has a reduced breaking moment in the event of a torsional load relative to an adjacent structural region of the receiving bushes. In particular, it can be provided that the connecting region has a plurality of circumferentially distributed and radially extending bores or a circumferentially extending weld seam, wherein a reduced breaking moment is imposed indirectly via the bores or the weld seam.

The receiving bushes are arranged coaxially to each other and are preferably cylindrical and have a profiling on an inner surface for torque transmission between the receiving bush and the drive unit, on the one hand, and the extruder screw, on the other hand.

The drive unit may comprise a drive motor and a transmission ratio stage or a transmission. The power splitting is usually carried out via a transmission. Upstream of the transmission, a belt drive can also be connected between the motor and the transmission in order to achieve a greater transmission ratio. The drive unit can be used to distribute or split the torque provided between both extruder screws. It is preferable if the torque is distributed equally between the extruder screws. Each shaft end of the drive unit is assigned to a specific output shaft of the drive unit.

The connecting region forms the transition between the two receiving bushes. The two receiving bushes are designed as a single component, i.e., in one piece, because of the connecting region. This does not affect the fact that the two receiving bushes may be present at a time during the production process as two separate workpieces which are separated from each other. The connecting region may generally comprise the same material as the adjacent structural region of the receiving bushes, as, for example, in the embodiment with the plurality of circumferentially distributed and radially extending bores. In the embodiment with the circumferentially extending weld seam, the connecting region may also comprise the material of the weld seam.

The torsional load is produced during standard operation of the twin screw extruder as a result of the drive torque applied by the drive unit, on the one hand, and the resistance opposed by the extruder screws, on the other hand, as a result of the extrusion material to be processed.

The embodiments of the coupling element, either with the circumferentially distributed and radially extending bores or the circumferentially extending weld seam, form a predetermined breaking point, which falls in the event of overload and thus protects the other system components. However, no additional shearing element, e.g., shearing pins, is used, but the coupling element itself has a weakened region. This region is designed in such a way that it can be modified with as few adjustments as possible in such a way that a defined breaking moment can be achieved with the aid of calculations.

The embodiments of the coupling element, either with the circumferentially distributed and radially extending bores or the circumferentially extending weld seam, enable an even more compact construction than the conventional designs allow. In particular, no additional axial installation space is required compared to the conventional designs. The coupling element can also be used to retrofit existing systems, since the required installation space and the connection dimensions can be selected to be identical.

In a preferred refinement, the connecting region forms a reduced cross section compared to the adjacent structural region as a result of the bores or the weld seam. A predetermined breaking point is thereby inserted into the connecting region. In particular, it can be provided that the connecting region is designed with respect to the breaking moment to be achieved via the bore diameter and the circumferential distance of the bores from each other and/or the inner diameter and the outer diameter, in particular the weld seam.

In the embodiment with the circumferentially distributed and radially extending bores, it is preferably provided that the circumferential distance between the bores is at most 1.5 times, in particular at most 1.2 times, the bore diameter. This ensures that a defined crack progression occurs in the fracture plane, since the torsional shearing stresses act at an angle of 45°.

The object is also achieved by a twin screw extruder with a drive unit and two extruder screws driven by the drive unit in a power-split manner, characterized in that the drive unit is connected to the extruder screws via one coupling element each as claimed in any one of the preceding claims.

Below, the invention will be explained by way of example with reference to the appended drawings on the basis of preferred exemplary embodiments, wherein the features presented below may in each case individually or in combination represent an aspect of the invention. It is shown in:

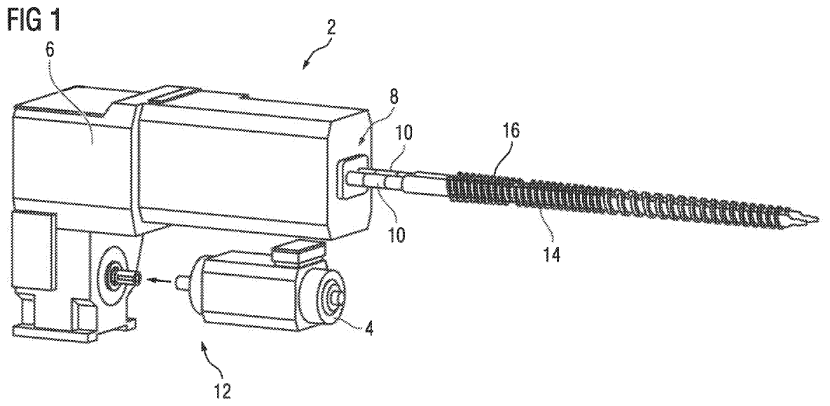

FIG. 1: a perspective and partially exploded illustration of a twin screw extruder;

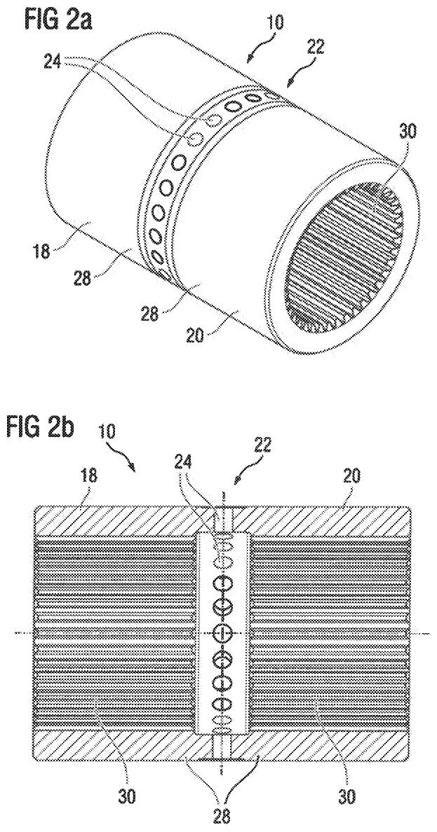

FIGS. 2a) and 2b): a perspective and a sectioned illustration of a first embodiment of a coupling element, and

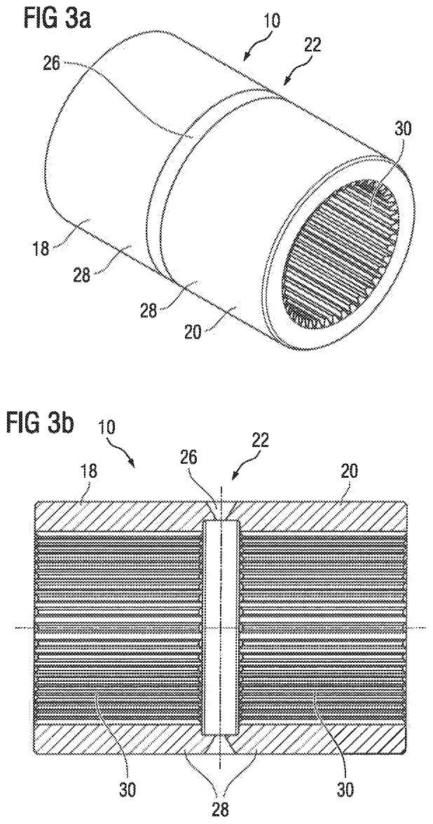

FIGS. 3a) and 3b): a perspective and a sectioned illustration of a second embodiment of a coupling element.

FIG. 1 shows a twin screw extruder 2 in a perspective and partially exploded illustration. The twin screw extruder 2 structurally comprises a drive unit 12, which in the present case is composed of a motor unit 4 and a transmission unit 6. The transmission unit 6 can transmit the drive torque of the motor unit 4 in a power-split manner to two output shafts 8 arranged parallel to each other. A first and a second extrusion screw 14, 16 are connected to the two output shafts 8 in each case via a coupling element 10. The two extrusion screws 14, 16 are at a small axial distance from each other, in accordance with the output shafts 8. Other components of the system may be cylinders, filling hoppers, heating bands, nozzles and a machine frame, which is not shown, however.

FIGS. 2 and 3 show, in each case in a perspective and a sectioned illustration a) and b), two embodiments of a coupling element 10 according to the invention. In each embodiment, the coupling element 10 comprises two receiving bushes 18, 20, which are connected to each other in a connecting region 22. The two receiving bushes 18, 20 are preferably designed identically and placed concentrically against each other and connected to each other via the connecting region 22. The first receiving bush 18 is provided for receiving a shaft end of the drive unit 12 and the second receiving bush 20 for receiving one of the extruder screws 14, 16. Here, an inner circumference of each of the receiving bushes 18, 20 forms a longitudinal toothing which can form a form-fitting connection for torque transmission with a corresponding longitudinal toothing 30 of the drive shafts of the drive unit 12 and the extruder screw 14, 16. The connecting region 22 has a plurality of circumferentially distributed and radially extending bores 24—see FIGS. 2a) and 2b)—or a circumferentially extending weld seam 26—see FIGS. 3a) and 3b). The connecting region has in any case a reduced breaking moment compared to an adjacent structural region 28 of the receiving bushes 18, 20 under a torsional load.

In the cross-sectional illustrations of FIGS. 2b) and 3b), it can be seen that the connecting region 22 forms a reduced cross section compared to the adjacent structural region 28 as a result of the bores 24 or the weld seam 26. The connecting region 22 is designed with respect to the breaking moment to be achieved via the bore diameter and the circumferential distance of the bores 24 from each other and the inner diameter and the outer diameter of the weld seam 26. It is preferred, as illustrated here, that a radial dimension of the connecting region does not exceed a radial dimension of the interconnected receiving bushes, The circumferential distance between the bores 24 is preferably at most 1.5 times, in particular at most 1.2 times, the bore diameter.

### LIST OF REFERENCE SIGNS

2 Twin screw extruder

4 Motor unit

6 Transmission unit

8 Output shaft

10 Coupling element

12 Drive unit

14 Extruder screw

16 Extruder screw

18 Receiving bush

20 Receiving bush

22 Connecting region

24 Bore

26 Weld seam

28 Structural region

30 Longitudinal toothing

What is claimed is:

1-8. (canceled)

9. A coupling element for connecting an extruder screw to a drive unit of a twin screw extruder, the coupling element comprising:
two receiving bushes connected to each other in a connecting region, with a first one of two receiving bushes designed to receive a shaft end of the drive unit and a second one of the two receiving bushes designed to receive the extruder screw, wherein the connecting region includes a plurality of circumferentially distributed and radially extending bores or a circumferentially extending weld seam, wherein the connecting region includes via the bores or the weld seam a reduced breaking moment in an event of a torsional load relative to an adjacent structural region of the two receiving bushes.

10. The coupling element of claim 9, wherein the connecting region forms a reduced cross section compared to the adjacent structural region as a result of the bores or the weld seam.

11. The coupling element of claim 9, wherein the connecting region is designed with respect to the breaking moment to be achieved via a bore diameter and a circumferential distance of the bores from each other and/or an inner diameter and an outer diameter, in particular of the weld seam.

12. The coupling element of claim 9, wherein the breaking moment lies within a range of between 11,000 Nm and 14,000 Nm.

13. The coupling element of claim 11, wherein a circumferential distance between the bores is at most 1.5 times, in particular at most 1.2 times, the bore diameter the bore diameter.

14. The coupling element of claim 9, wherein a radial dimension of the connecting region does not exceed a radial dimension of the interconnected two receiving bushes.

15. A twin screw extruder, comprising:
a drive unit;
two extruder screws driven by the drive unit in a power-split manner; and
a coupling element connecting the drive unit to the two extruder screws, said coupling element comprising two receiving bushes connected to each other in a connecting region, with a first one of two receiving bushes designed to receive a shaft end of the drive unit and a second one of the two receiving bushes designed to receive the extruder screw, wherein the connecting region includes a plurality of circumferentially distributed and radially extending bores or a circumferentially extending weld seam, wherein the connecting region includes via the bores or the weld seam a reduced breaking moment in an event of a torsional load relative to an adjacent structural region of the two receiving bushes.

16. The twin screw extruder of claim 15, wherein the connecting region forms a reduced cross section compared to the adjacent structural region as a result of the bores or the weld seam.

17. The twin screw extruder of claim 15, wherein the connecting region is designed with respect to the breaking moment to be achieved via a bore diameter and a circumferential distance of the bores from each other and/or an inner diameter and an outer diameter, in particular of the weld seam.

18. The twin screw extruder of claim 15, wherein the breaking moment lies within a range of between 11,000 Nm and 14,000 Nm.

19. The twin screw extruder of claim 17, wherein a circumferential distance between the bores is at most 1.5 times, in particular at most 1.2 times, the bore diameter the bore diameter.

20. The twin screw extruder of claim 15, wherein a radial dimension of the connecting region does not exceed a radial dimension of the interconnected two receiving bushes.
